(19) United States
(12) Patent Application Publication
(10) Pub. No.: US 2002/0004841 A1
(43) Pub. Date: Jan. 10, 2002

(54) Communication apparatus and communication method

(76) Inventor: Ryusuke Sawatari, Kanagawa (JP)

Correspondence Address: William S. Frommer, Esq., FROMMER LAWRENCE & HAUG LLP, 745 Fifth Avenue, New York, NY, 10151, US

(21) Appl. No.: 09/846,701

(22) Filed: May 1, 2001

(30) Foreign Application Priority Data
May 2, 2000 (JP) 2000-138245

(51) Int. Cl. G06F 15/16

(52) U.S. Cl. 709/232; 709/231

(57) ABSTRACT

While transmitting real-time data through a network 30, a data-transmitting apparatus 10 receives the data representing a data-loss rate, from a data-receiving apparatus 20. In the data-transmitting apparatus 10, the rate control section 15 compares the data-loss rate with the preset first and second threshold values. When the data-loss rate is lower than both the first threshold value and the second threshold value, the rate control section increases the transfer rate at which the data-transmitting means transmits the real-time data. When the data-loss rate is higher than the first threshold value and lower than the second threshold value, the rate control section does not change the transfer rate. When the data-loss rate is higher than both the first threshold value and the second threshold value, the rate control section decreases the transfer rate.

### BACKGROUND OF THE INVENTION

The invention relates to a communication apparatus and a communication method, both designed to transmit real-time data such as movie image data and audio data through a communication network such as the Internet.

In recent years, systems for transmitting real-time data, such as movie image data and audio data, through a communication network such as the Internet are put to use in increasing numbers. Since many people use the public network such as the Internet, data may therefore be congested in the network. A method of controlling the data congestion is very important. That is, it is necessary to avoid data congestion and subdue the same.

Various methods of controlling data congestion have been proposed with regard to non-real-time communication, such as transfer of files. Now that more and more data should be transferred in real time, it is important to control the congestion of real-time data.

A congestion control is practiced in the real-data communication, such as the transmission of movie data. When no data congestion occurs in the network, the encoding rate is raised, thus transmitting movie image data that has high quality. When data congestion takes place in the network, the encoding rate is lowered, thus transmitting the movie image data that has but low quality.

More specifically, in the data-transmitting side, the encoding rate is gradually increased until data congestion happens in the network. When data congestion occurs in the network, the encoding rate is decreased to control the data congestion. When the data congestion is thereby eliminated, the encoding rate is increased again.

In the data-transmitting side it is necessary to determine whether data is congested in the network. To this end, RTP (Real-Time Transport Protocol) and RTCP (RTP Control Protocol), both standardized as RFC 1889/1890, are utilized in many cases.

The RTP is a protocol that is applied in transmitting real-time data from a data-transmitting side and a data-receiving side. In order to transmit real-time data in accordance with the RTP, the data-transmitting side generates an RTP packet that has a header containing data items representing the type, sequence number, time stamp and the like of the payload data.

The RTCP is a protocol describing that the communication quality QoS of data to be transferred in accordance with the RTP should be monitored and that the participants of an RTP cession should be informed of control data.

In the RTCP, a data-transmitting apparatus transmits a sender report packet to a data-receiving apparatus, informing the latter of the data-transmitting state. Upon receipt of the sender report packet, the data-receiving apparatus transmits a receiver report packet to the data-transmitting apparatus, informing the data-transmitting apparatus of the data-receiving state. The transmission and receipt of an RTP packet is thereby controlled.

The sender report packet contains data items representing the time of transmitting any RTP packet, the number of RTP packets transmitted, the number of bytes constituting each RTP packet transmitted, and the like.

The receiver report packet contains data items representing the rate of losing RTP packets, the number of packets lost, the largest sequence number of any RTP packet received, the interarrival jitter, the time of receiving the last sender-report packet, the period from this time, and the like.

The data-receiving apparatus transmits an RTCP packet to the data-transmitting apparatus at regular intervals (e.g., 5 seconds). From the RTCP packet the data-transmitting apparatus detects the rate of data loss that has occurred during the data transmission to the data-receiving apparatus. If the data-loss rate is high, the data-transmitting apparatus determines that data has been congested in the network, probably discarding some data items at relay nodes. If the data-loss rate is zero (0), the data-transmitting apparatus determines that no data congestion is happening in the network.

The loss of data occurring in the network does not always result from the data congestion. Rather, it may result from the bit errors made in the process of transmitting data. Alternatively, the loss of data may be nothing more than a temporary one caused by traffic burst.

If the data-transmitting apparatus decreases the encoding rate in response to a temporary loss of data, though no data congestion takes place in the network, the real-time data (e.g., movie image data and audio data) will unnecessarily be degraded in quality. This problem is particularly prominent in the case where the real-time data is transmitted in accordance with the RTP and the RTCP as indicated above.

### BRIEF SUMMARY OF THE INVENTION

The present invention has been made in view of the foregoing. An object of the invention is to provide a communication apparatus and a communication method, which do not respond too much to a loss of data during the transmitting of real-time data, thereby stabilizing the quality of communication.

To achieve the object, a communication apparatus according to the present invention comprises: data-transmitting means for transmitting real-time data through a communication network; data-receiving means for receiving data representing data-loss rate, from a data-receiving side to which the data-transmitting means transmits the real-time data; and rate control means for comparing the data-loss rate with preset first and second threshold values, increasing a transfer rate at which the data-transmitting means transmits the real-time data, when the data-loss rate is lower than both the first threshold value and the second threshold value, not changing the transfer rate when the data-loss rate is higher than the first threshold value and lower than the second threshold value, and decreasing the transfer rate when the data-loss rate is higher than both the first threshold value and the second threshold value.

In the communication apparatus, the rate control means increases, decreases or does not change the transfer rate by the first and the second threshold values in accordance with the data representing the data-loss rate, which has been transmitted from the data-receiving side.

To achieve the above-mentioned object, a communication method according to the invention comprises: receiving data representing data-loss rate, from a data-receiving side, while real-time data is being transmitted through a communication network; comparing the data-loss rate with preset first and second threshold values; and increasing a transfer rate at which the real-time data is transmitted, when the data-loss rate is lower than both the first threshold value and the second threshold value, not changing the transfer rate when the data-loss rate is higher than the first threshold value and lower than the second threshold value, and decreasing the transfer rate when the data-loss rate is higher than both the first threshold value and the second threshold value.

In the communication method, the transfer rate is increased, decreased or not changed at all by the first and the second threshold values, in accordance with the data representing the data-loss rate, which has been transmitted from the data-receiving side.

Thus, the present invention can provide a communication apparatus and a communication method, in which the transfer rate is increased or decreased or not changed at all in accordance with the data transmitted from the data-receiving side and representing the data-loss rate. Hence, the data-transmitting side does not respond too much to a loss of data that occurs during the transmitting of real-time data. The quality of communication is thereby stabilized.

### BRIEF DESCRIPTION OF THE SEVERAL VIEWS OF THE DRAWING

FIG. 1 is a block diagram showing a communication system according to the present invention;

FIG. 2 is a diagram illustrating the data configuration of the RTP header contained in a RTP packet to be transmitted from a data-transmitting apparatus to which the present invention is applied;

FIG. 3 is a diagram depicting the data configuration of the RTCP-sender report packet generated in the sender-side RTCP transmitting section incorporated in the data-transmitting apparatus;

FIG. 4 is a diagram showing the data configuration of the RTCP-receiver report packet generated in the receiver-side RTCP transmitting section incorporated in a data-receiving apparatus according to the invention;

FIG. 5 is a flowchart explaining how the rate control section provided in the data-transmitting apparatus controls the rate of transferring RTP packets; and

FIG. 6 is a diagram for explaining first and second threshold values preset for the rate of losing data, and a data-loss state determined by using the first and second threshold values.

### DETAILED DESCRIPTION OF THE INVENTION

An embodiment of the present invention will be described in detail, with reference to the accompanying drawings.

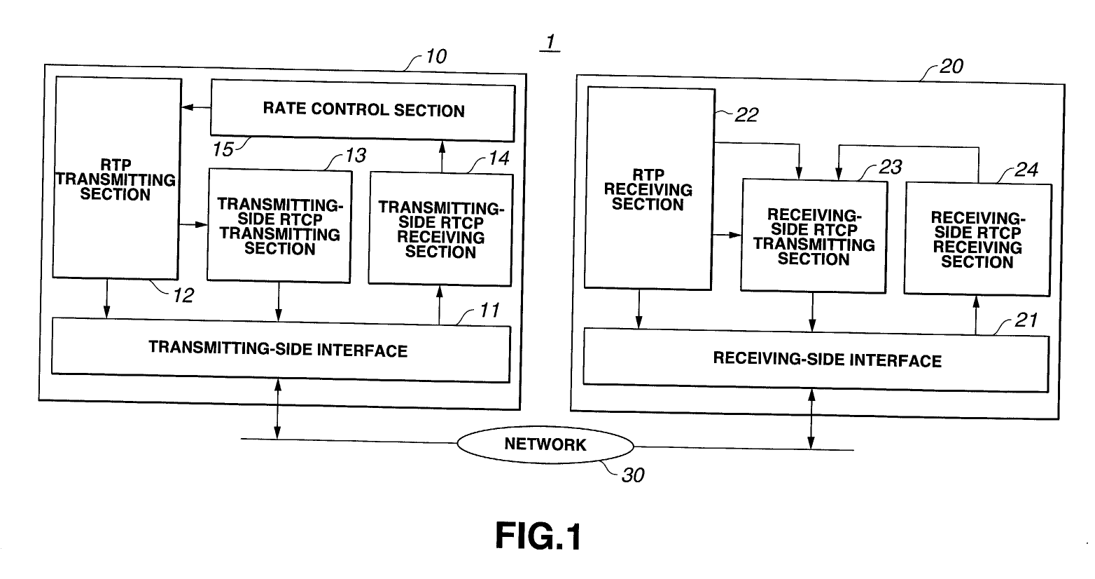

The invention is applied to, for example, the communication system 1 shown in FIG. 1.

The communication system 1 comprises a data-transmitting apparatus 10 and a data-receiving apparatus 20. The data-transmitting apparatus 10 and the data-receiving apparatus 20 are connected by a network 30.

The network 30 is a public communication network such as the Internet. It comprises a plurality of relay nodes that connect the data-transmitting apparatus 10 and the data-receiving apparatus 20 to each other. Real-time data and various control data items are transmitted through the network 30.

The data-transmitting apparatus 10 comprises a transmitting-side interface 11, an RTP transmitting section 12, a transmitting-side RTCP transmitting section 13, a transmitting-side RTCP receiving section 14, and a rate control section 15. The transmitting-side interface 11 is connected to the network 30.

The transmitting-side interface 11 comprises a communication interface circuit that is connected to the network 30. The interface 11 transmits packets to the data-receiving apparatus 20 trough the network 30. It receives packets from the data-receiving apparatus 20 and supplies them to the other components of the data-transmitting apparatus 10.

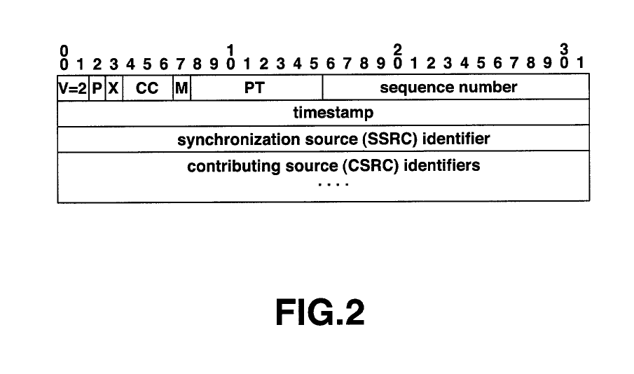

The RTP transmitting section 12 receives real-time data, such as movie image data and audio data, from external apparatuses, so that the real-time data may eventually transmitted to the data-receiving apparatus 20. The section 12 generates RTP packets from the real-time data, in accordance with the RTP. Each RTP packet the section 12 generates contains an RTP header that is shown in FIG. 2. (The RTP header will be described later in detail.) The section 12 outputs the RTP packets to the transmitting-side interface section 11, so that the real-time data may be transferred to the data-receiving apparatus 20 in the form of RTP packets.

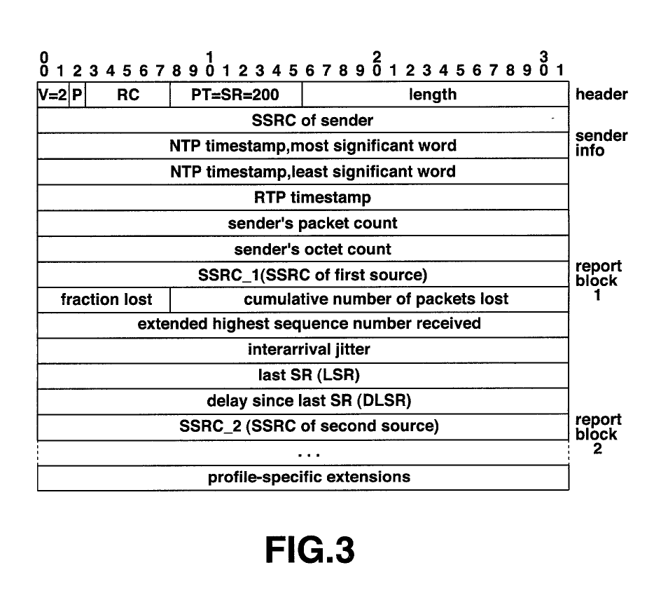

The transmitting-side RTCP transmitting section 13 has the function of informing the data-receiving apparatus 20 of the data-transmitting state. The data-receiving apparatus 20 can therefore monitor the communication quality QoS of the data to be transferred to it in accordance with the RTP, as is described by the RTCP. The section 13 generates an RTCP-sender report packet shown in FIG. 3 to inform the data-receiving apparatus 20 of the data-transmitting state. (The RTCP-sender report packet will be described later in detail.) The transmitting-side RTCP transmitting section 13 acquires from the RTP transmitting section 12 the data representing the data amount of the RTP packet, in order to transmit the RTP packet to the data-receiving apparatus 20. The section 13 generates an RTCP-sender report packet from the data it has acquired from the RTP transmitting section 12. The RTCP-sender report packet is output to the transmitting-side interface section 11.

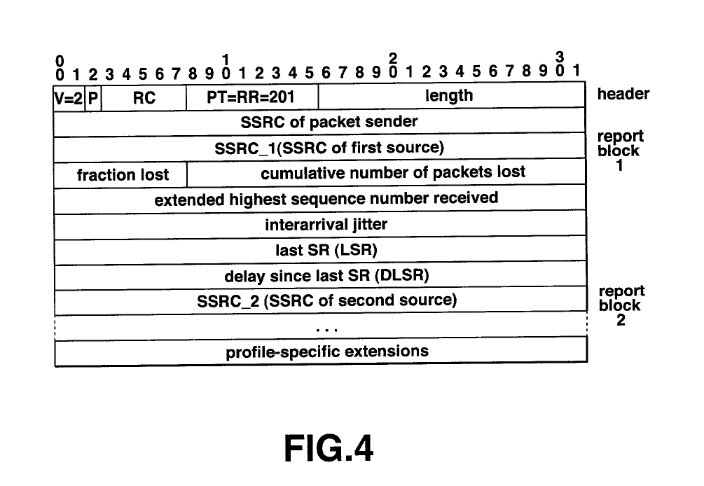

The transmitting-side receiving section 14 has the function of detecting the data-receiving state in which the data-receiving apparatus 20 is receiving data from the data-transmitting apparatus 10. The data-transmitting apparatus 10 can therefore monitor, as is described by the RTCP, the communication quality QoS of the data transferred from it to the data-receiving apparatus 20 in accordance with the RTP. To state it more specifically, the section 14 receives an RTCP-receiver report packet shown in FIG. 4 to detect the state in which the data-receiving apparatus 20 is receiving data. The section 14 analyzes the RTCP-receiver report packet, finding the data-loss rate, the number of packets lost and the like. The section 14 generates data representing the data-loss rate, the number of packets lost and the like and supplies the data to the rate control section 15.

The rate control section 15 controls the rate of transferring RTP packets to transmit from the RTP transmitting section 12. The rate control section 15 receives the data-loss rate from the transmitting-side RTCP receiving section 14 and determines the RTP-packet transfer rate from the data-loss rate. The RTP-packet rate is supplied to the RTP transmitting section 12.

In the data-transmitting apparatus 10, the transmitting-side interface 11 converts the RTP packet generated by the RTP transmitting section 12, into a signal that can be transferred through the network 30. The data-transmitting apparatus 10 can therefore transmit the real-time data to the data-receiving apparatus 20 at the transfer rate by the rate control section 15. The transmitting-side interface 11 receives the RTCP-sender report packet from the transmitting-side RTCP transmitting section 13 and periodically transmits the same to the data-receiving apparatus 20 through the network 30. Upon receipt of the RTCP-sender report packet, the data-receiving apparatus 20 transmits an RTCP-receiver report packet to the data-transmitting apparatus 10. The transmitting-side interface 11 receives the RTCP-receiver report packet and supplies the same to the transmitting-side receiving section 14.

The data-receiving apparatus 20 comprises a receiving-side interface 21, an RTP receiving section 22, a receiving-side RTCP transmitting section 23, and a receiving-side RTCP receiving section 24.

The receiving-side interface 21 has an interface circuit that is connected to the network 30. The interface 21 receives packets from the data-transmitting apparatus 10 via the network 30. It supplies the packets to the other components of the data-receiving apparatus 20.

The RTP receiving section 22 receives any RTP packet from the receiving-side interface 21, which has received the RTP packet from the data-transmitting apparatus 10. It analyzes the RTP packet and extracts the real-time data from the RTP packet. The real-time data thus extracted is output from the data-receiving apparatus 20.

Upon receipt of the RTP packet, the RTP receiving section 22 calculates the data-loss rate for the RTP packet. The section 22 outputs the data-loss rate to the receiving-side RTCP transmitting section 23.

The receiving-side RTCP receiving section 24 has the function of detecting the data-transmitting state in which the data-transmitting apparatus 10 is transmitting data to the data-receiving apparatus 20. The data-receiving apparatus 20 can therefore monitor, as is described by the RTCP, the communication quality QoS of the data transferred to it from the data-transmitting apparatus 10 in accordance with the RTP. More precisely, the receiving-side RTCP receiving section 24 receives an RTCP-sender report packet periodically transmitted from the data-transmitting apparatus 10. The section 24 then supplies the RTCP-sender report packet to the receiving-side RTCP transmitting section 23, so that the receiving-side RTCP transmitting section 23 may generate an RTCP-receiver report packet.

The receiving-side RTCP transmitting section 23 has the function of informing the data-receiving state in which the data-receiving apparatus 20 is receiving data from the data-transmitting apparatus 10. The data-receiving apparatus 20 can therefore monitor, as is described by the RTCP, the communication quality QoS of the data transferred to it from the data-transmitting apparatus 10 in accordance with the RTP. The receiving-side RTCP transmitting section 23 generates an RTCP-receiver report packet in order to inform the data-receiving state. The RTCP-receiver report packet will be described later in FIG. 4. To be more specific, the section 23 finds the data-loss rate for the RTP packet the RTP receiving section 22 has received from the RTP transmitting section 12 of the data-transmitting apparatus. The section 23 then generates an RTCP-receiver report packet, which is transmitted via the receiving-side interface 21 and the network 30 to the transmitting-side interface 11 of the data-transmitting apparatus 10.

In the data-receiving apparatus 20, the receiving-side interface 21 converts the RTP packet into a signal of a specific format so that the apparatus 20 may receive the real-time data from the data-transmitting apparatus 10. The signal is supplied to the RTP receiving section 22. The receiving-side interface 21 periodically receives an RTCP-sender report packet from the data-transmitting apparatus 10 through the network 30 and supplies the same to the receiving-side RTCP receiving section 24. The interface 21 also receives the RTCP-receiver report packet from the receiving-side RTCP transmitting section 23. The RTCP-receiver report packet is supplied to the data-transmitting apparatus 10 via the network 30.

FIG. 2 illustrates the data configuration of the RTP header contained in any RTP packet.

As FIG. 2 shows, the RTP header comprises storage sections for storing various data items. The data items are version (e.g., V=2), padding (P), extension bits (X), CSRC (contributing source) count (CC), marker (M), payload type (PT), sequence number, time stamp, SSRC (synchronization source) identifier, and CSRC identifier. The storage sections are arranged in the order they have just mentioned. Real-time data follows the CSRC storage section.

The version storage section stores the data representing the version of the RTP applied. More precisely, the section stores “2” if the second version of RTP is utilized.

The payload storage section holds the data showing the type of the real-time data. This data indicates that the real-data is, for example, video data, audio data or the like.

The sequence number storage section stores a sequence number that is increased by one every time an RTP packet is transmitted or received during an RTP cession. The sequence number therefore indicates how many RTP packets have been already transmitted or received.

The time stamp storage section stores the time stamp that shows the time (day and hour) the real-time data was generated or updated.

The SSRC identifier storage section and the CSRC identifier storage section hold data item that identify the source of the data transmitted during the RTP cession.

The RTP transmitting section 12 stores various data items into the storage sections described above, before the real-time data is transmitted from the data-transmitting apparatus 10 in accordance with the RTP. The RTP receiving section 22 detects these data items and extracts the real-time data.

FIG. 3 depicts the data configuration of an RTCP-sender report packet.

The RTCP-sender report packet has a header data field, a sender information field, and report block field. These fields are arranged in the order they are mentioned. The report information field has a plurality of sub-fields that correspond to the sources provided in the data-transmitting apparatus.

The header data field comprises storage sections for storing various data items. The data items are version (V), padding (P), reception report count (RC), payload type (PT), data length, and sender identifier (SSRC of sender). These storage sections are arranged in the other they are mentioned.

The sender information field comprises storage sections for storing various data items. The data items are NTP (network time protocol) time stamp, RTP time stamp (RTP timestamp), sender's packet count, and sender's octet count.

The report block field comprises storage sections for storing various data items. These data items are SSRC-1 (SSRC of first source), data-loss rate (fraction lost), cumulative number of packets lost, extended highest sequence number received, interarrival jitter, last SR (LSR), and delay since last SR (DLSR).

In the header data field of the RTCP-sender report packet, the payload type storage section stores the payload type data supplied from the transmitting-side RTCP transmitting section 13. The payload type data is a value “200” that indicates that the payload is an RTCP sender report.

The data length storage section stores the data representing the length of the entire RTCP-sender report packet, which has been supplied from the transmitting-side RTCP transmitting section 13.

The sender identifier storage section of the header data field holds the sender identifier that identifies the sender that is transmitting data. The sender identifier has been supplied from the transmitting-side RTCP transmitting section 13.

The NTP time stamp storage section stores the data showing the time (day and hour) when the data-transmitting apparatus 10 transmits a sender-report packet. The time data has been supplied from the transmitting-side RTCP transmitting section 13.

The RTP time stamp storage section also stores the data showing the time (day and hour) when the data-transmitting apparatus 10 transmits an RTP packet. This time data has been supplied from the transmitting-side RTCP transmitting section 13, too.

The sender's packet count storage section holds a sender's packet count that represents the number of RTP packets the data-transmitting apparatus 10 has transmitted within a prescribed period. The sender's packet count has been supplied from the transmitting-side RTCP transmitting section 13.

The sender's octet count storage section stores the data representing the amount of data contained in the RTP packets that the data-transmitting apparatus 10 has transmitted within a prescribed period. This data has been supplied from the transmitting-side RTCP transmitting section 13, too.

Note that data identical in configuration to the RTCP-receiver report packet, which will be later described, is written in the report block field. The data described in the report block field is used not only while the data-transmitting apparatus 10 is transmitting data, but also while the apparatus 10 is receiving data.

FIG. 4 shows the data configuration of the RTCP-receiver report packet.

In the report block field, the resource data storage section stores the data identifying the transmitting-side RTCP transmitting section 13 that transmits RTCP packets. This data has been sent from the transmitting-side RTCP transmitting section 13.

The data-loss rate storage section stores the data indicative of the rate at which data is lost when the data-receiving apparatus 20 receives RTP packets from the data-transmitting apparatus 10. This data has been supplied from the receiving-side RTCP transmitting section 23.

The packet cumulative number storage section holds the data showing the cumulative number of packets that have been lost before the data-receiving apparatus 20 receives RTP packets from the data-transmitting apparatus 10. The data has been supplied from the receiving-side RTCP transmitting section 23, too.

The sequence number storage section stores the data representing the sequence number contained in the last RTP packet the data-receiving apparatus 20 has received. That is, this storage section holds the highest sequence number received. The data showing the highest sequence number has been supplied from the receiving-side RTCP transmitting section 23.

The interarrival jitter storage section stores the data representative of the time intervals at which the data-receiving apparatus 20 receives RTP packets. This data has been supplied, also from the receiving-side RTCP transmitting section 23.

The last SR (LSR) storage section holds the data showing the time at which the data-receiving apparatus 20 receives the last RTP packet from the data-transmitting apparatus 10. The data has been supplied from the receiving-side RTCP transmitting section 23, too.

The DLSR (delay since last SR) storage section stores the data indicating the time that has elapsed from the time represented by the data stored in the last SR (LSR) storage section.

Thus, RTCP-sender report packets and RTCP-receiver report packages are transferred in the communication system 1 described above. In the data-transmitting apparatus 10, the sender's packet count storage section holds the sender's packet count that represents the number of RTP packets transmitted, and the sender's octet count storage section stores the data representing the amount of data contained in the RTP packets transmitted. Two data items respectively representing the number of RTP packets and the amount of data contained therein are supplied to the data-receiving apparatus 20. Thus, the data-transmitting apparatus 10 informs the data-receiving apparatus 20 of the state in which the RTP packets are transmitted from it to the data-receiving apparatus 20.

The data-receiving apparatus 20 calculates the ratio of the number of plackets lost to the number of packets it should receive while the data-transmitting apparatus 10 are continuously transmitting two sender report packets. More specifically, the apparatus 20 finds the ratio between the number of packets represented by the data it has received and the number of packets the RTP receiving section 22 has actually received, thereby determining the number of the packets lost. The apparatus 20 also calculates a data-loss rate from the ratio between the amount of data represented by the information it has received from the apparatus 10 and the amount of data contained in the RTP packets it has actually received from the apparatus 10.

In the data-receiving apparatus 20, the data-loss rate storage section stores the data-loss rate thus calculated. An RTCP-receiver report packet is generated. This packet has a packet cumulative number storage section that holds the data showing the cumulative number of packets that have been lost. The apparatus 20 transmits the RTCP-receiver report packet to the data-transmitting apparatus 10, thus informing the apparatus 10 of the state in which the apparatus 20 is receiving the RTP packets.

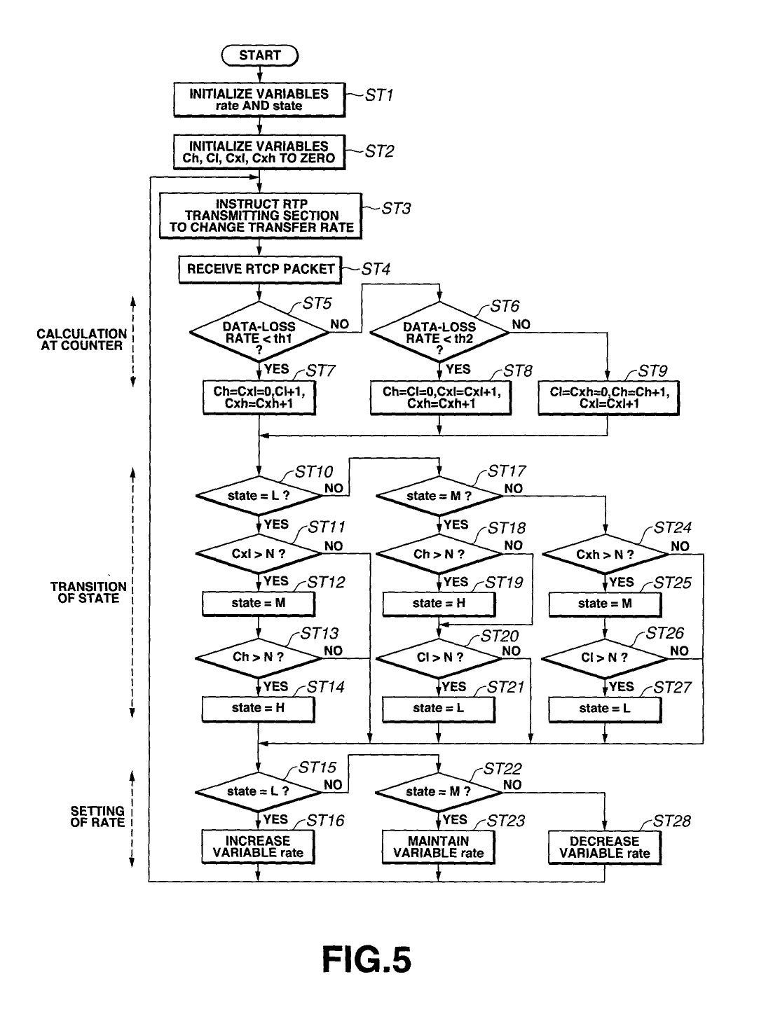

How the rate control section 15 controls the transfer rate while the data-transmitting apparatus 10 is transmitting RTP packets will be explained, with reference to the flowchart of FIG. 5.

First, the rate control section 15 initializes a variable rate that holds the transfer rate, at an appropriate value, and initializes a variable state in accordance with the data-loss rate (Step ST1). The rate controller 15 has a counter that counts, at prescribed time intervals, a data-loss state found to exist on the basis of the data-loss rate. The count of the counter is initialized to “0.” The maximum count N is set in the counter.

Then, the rate control section 15 initializes the count Ch for a region H, the count Cl for a region L, the count Cxh for an extra-H region, and the count Cxl for an extra-L region, all to “0” (Step ST2).

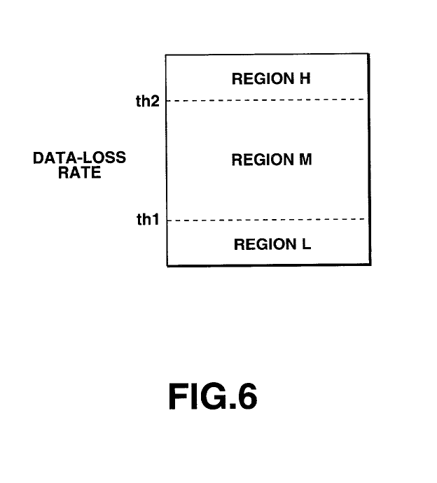

The count Ch for the region H indicates the number of times the data-loss rate has been continuously detected in the region H shown in FIG. 6. The count Cl for the region L represents the number of times the data-loss rate has been continuously detected in the region L shown in FIG. 6. The count Cxh for the extra-H region shows the number of times the data-loss rate has been continuously detected in the extra-H region illustrated in FIG. 6. The count Cxl for the extra-L region represents the number of times the data-loss rate has been continuously detected in the extra-L region shown in FIG. 6.

The rate control section 15 holds two threshold value th1 and th2 for the data-loss rate, as is illustrated in FIG. 6. If the data-loss rate is lower than the first threshold value th1, the rate control section 15 determines that the data-loss rate lies in the region L. If the data-loss rate is higher than the first threshold value th1 and lower than the second threshold value th2, the rate control section 15 determines that the data-loss rate lies in the region M. If the data-loss rate is higher than the second value th2, the rate control section 15 determines that the data-loss rate lies in the region H. The level of the above-mentioned data-loss state changes in accordance with which region the data-loss rate lies in. More correctly, the data-loss state is at level H when the data-loss rates lies in the region H, at level M when the rate lies in the region M, and at level L when the rate lies in the region L.

Next, the rate control section 15 controls the RTP transmitting section 12, making the same to transmit RTP packets at the rate initialized in Step ST1 (Step ST3). Thus controlled, the RTP transmitting section 12 transmits the RTP packets at the transfer rate initialized, to the data-receiving apparatus 20. In the data-transmitting apparatus 10, the transmitting-side RTCP transmitting section 13 transmits an RTCP-sender report packet to the data-receiving apparatus 20.

The transmitting-side RTCP receiving section 14 receives an RTCP-receiver report packet from the data-receiving apparatus 20 and supplies the same to the rate control section 15 (Step ST4).

The rate control section 15 determines whether the data-loss rate supplied from the transmitting-side RTCP receiving section 14 is lower than the first threshold value th1 or not (Step ST5).

The rate control section 15 may determine that the data-loss rate is lower than the first threshold value th1 and that the data-loss rate lies in the region L. If so, the section 15 resets the count Ch for the region H and the count Cxl for the extra-L region, both at “0” and increases the count Cl for the region L and the count Cxl for the extra-L region (Step ST7).

If the rate control section 15 determines that the rate-loss rate is higher than the first threshold value th1, it determines whether the rate is lower than the second threshold value th2 (Step ST6).

If the rate control section 15 determines that the data-loss rate is lower than the second threshold value th2, it determines that the rate lies in the region M that extends between the first threshold value th1 and the second threshold value th2. In this case, the section 15 resets the count Ch for the region H and the count Cl for the region L, both at “0” and increases, by one, the count Cxl for the extra-L region and the count Cxh for the extra-H region (Step ST8).

The rate control section 15 may determine that the data-loss rate is higher than the second threshold value th2. In this case, the section 15 determines that the data-loss rate lies in the region H that is higher than both the first threshold value th1 and the second threshold value th2. The section 15 then resets the counts Cl and Cxh at “0” and increases the counts Ch and Cxl by one (Step ST9).

Thus performing Steps ST5 to ST9, the rate control section 15 obtains, from the transmitting-side receiving section 14, the data-loss rate at which data is lost while the data-transmitting apparatus 10 is transmitting RTP packets at the transfer rate determined in Step ST3. In accordance with the data-loss rate, the section 15 drives the counter, thereby calculating the count Cxh for the extra-H region, the count Ch for the region H, the count Cl for the region L and the count Cxl for the extra-L region.

Then, the rate control section 15 carries out the following sequence of operations to determine whether a data-loss state exists or not, from the various counts acquired in Steps ST5 to ST9.

First, the rate control section 15 determines whether the data-loss state is at “L” level (Step ST10). If the data-loss state is at “L” level, the section 15 carries out Steps ST11 to ST14 to determine whether it is necessary to shift the data-loss data from “L” level.

The rate control section 15 determines whether the count Cxl for the extra-L region is greater than the maximum value N or not (Step ST11). If the count Cxl is found greater than the value N, the section 15 shifts the data-loss state from “L” level to “M” level. In other words, the section 15 sets the data-loss state in the M region (Step ST12).

Next, the rate control section 15 determines whether the count Ch for the region H is greater than the maximum value N or not (Step ST13). If the count Ch is found greater than the value N, the section 15 shifts the data-loss state from “M” level to “H” level (Step ST14). The section 15 then goes to Step ST15.

If the count Cxl is found not greater than the maximum value N in Step ST11, the rate control section 15 determines that the data-loss state is at “L” level and goes to Step ST15. The control 15 advances to Step ST15, too, if it determines in Step ST13 that the count Ch is not greater than the maximum value H, indicating that the data-loss state is at “M” level.

In Step ST10 it may be determined that the data-loss state is not at “L” level. If so, the rate control section 15 determines whether the data-loss state is at “M” level or not (Step S 17). If the data-loss state is found at “M” level, the section 15 performs Steps ST18 to ST21 to determine whether it is necessary to shift the data-loss state from “M” level or not.

At first, the rate control section 15 determines whether the count Ch for the region H is greater than the maximum value N or not (Step ST18). If the count Ch is found greater than the value N, the section 15 shifts the data-loss state from “M” level to “H” level. That is, the section 15 determines that the data-loss rate lies in the region H (Step ST19). The count Ch may be found greater than the value N in Step S18. In this case, the rate control section 15 goes to Step ST20.

In Step ST20, the rate control section 15 determines whether the count Cl for the region L is greater than the maximum value N or not. If the count Cl is not greater than the value N, the section 15 advances to Step ST1 goes to Step ST15. If the count Cl is greater than the value N, the section 15 shifts the data-loss state from “H” level to “L” level (Step ST21). The, the rate control section 15 advances to Step ST15.

If the data-loss state is found not at “L” level in Step ST10 and not at “M” level in Step ST17, it performs Steps ST24 to ST27 to determine whether the data-loss state should be shifted from “H” level or not.

First, the rate control section 15 determines whether the count Cxh for the extra-H region is greater than the maximum value N (Step ST24) or not. If the count Cxh is determined to be greater than the value N, the section 15 shifts the data-loss state from “H” level to “M” level. That is, the rate control section 15 determines that the data-loss rate lies in the region M (Step ST25).

Next, the rate control section 15 determines whether the count Cl for the region L is greater than the maximum value (Step ST26). If the count Cl is found greater than the value N, the section 15 shifts the data-loss rate from “M” level to “L” level (Step ST27). Then, the rate control section 15 goes to Step ST15.

If the rate control section 15 determines in Step ST24 that the count Cxh for the extra-H region is greater than the maximum value N, it determines that the data-loss state is at “H” level. In this case, the section 15 goes to Step ST15. If the control section 15 determines in Step ST26 that the count Cl for the region L is not greater than the maximum value N, it determines that the data-loss state is at “M” level. If so, the section 15 advances to Step ST15, too.

Thus, the rate control section 15 shifts the data-loss state that corresponds to the rate at which data is lost while RTP packets are transmitted at the transfer rate determined in Step ST3, thereby detecting an accurate data-loss state.

In accordance with the accurate data-loss state thus detected, the rate control section 15 carries out the following sequence of steps, in order to control the variable “rate.”

At first, the rate control section 15 determines whether the data-loss state is at “L” level (Step ST15) or not. If the data-loss state is found to be at “L” level, the section 15 increases the variable “rate” previously set (Step ST16), and then goes to Step ST3. The section 15 controls the RTP transmitting section 12, making the section 12 transmit RTP packets at the transfer rate that corresponds to the variable “rate” thus increased. That is, the rate control section 15 determines that no data congestion is occurring in the network 30 if the data-loss state is found at “L” level. If so, the section 15 increases the transfer rate at which the RTP transmitting section 12 transmits RTP packets.

If the rate control section 15 determines in Step S15 that the data-loss state is not at “L” level, it determines whether the data-loss state is at “M” level (Step ST22) or not. If the data-loss state is found not at “M” level, the section 15 does not change the preset variable “rate,” and returns to Step ST3 (Step ST23). Thus, the rate control section 15 causes the RTP transmitting section 12 to transmit RTP packets at the transfer rate previously set. That is, if the data-loss state is at “M” level, the section 15 does not change the transfer rate set for the section 12 and monitors the condition in the network 30.

If the data-loss state is found not at “M” level, in Step ST22, the section 15 determines that the data-loss state is at “H” level. In this case, the section 15 does not change the preset transfer rate and goes to Step ST28. In Step ST28, the section 15 decreases the variable “rate” and causes the RTP transmitting section 12 to transmit RTP packets at the transfer rate based on the “rate” thus decreased. That is, if the section 15 determines that the data-loss state is at “H” level, it determines that data congestion is taking place in the network 30 and then decreases the transfer rate for the RTP transmitting section 12.

In the communication system 1, the rate control section 15 controls the transfer rate as described above when data congestion occurs in the network 30 during the transmission of real-time data through the network 30. More precisely, the section 15 compares the data-loss rate with two threshold values th1 and th2 to determine the data-loss state. If the data-loss rate is lower than the second threshold value th2, the section 15 does not change the transfer rate even if the data-loss rate is higher than the first threshold value th1. This prevents the encoding rate from being decreased in response to a temporary loss of data. As a result, the communication quality is stabilized. In other words, the system 1 does not respond too much to a loss of data caused by anything other than the data congestion in the network 30.

What is claimed is:

1. A communication apparatus comprising:
data-transmitting means for transmitting real-time data through a communication network;
data-receiving means for receiving data representing data-loss rate, from a data-receiving side to which the data-transmitting means transmits the real-time data; and
rate control means for comparing the data-loss rate with preset first and second threshold values, increasing a transfer rate at which the data-transmitting means transmits the real-time data, when the data-loss rate is lower than both the first threshold value and the second threshold value, not changing the transfer rate when the data-loss rate is higher than the first threshold value and lower than the second threshold value, and decreasing the transfer rate when the data-loss rate is higher than both the first threshold value and the second threshold value.

2. The communication apparatus according to claim 1, wherein the rate control means comprises counting means for setting the first threshold value at a value other than zero and for counting the number of times the data-loss rate corresponds to a first state in which the data-loss rate ranges from zero to the first threshold value, a second state in which the data-loss rate ranges from the first threshold value to the second threshold value, or a third state in which the data-loss rate exceeds the second threshold value, and the rate control means determines whether the data-loss rate corresponds to the first data-loss state, the second data-loss state or the third data-loss state in accordance with a count obtained by the counting means and controls the transfer rate in accordance with the data-loss state thus determined.

3. A communication method comprising:
receiving data representing data-loss rate, from a data-transmitting side, while real-time data is being transmitted through a communication network;
comparing the data-loss rate with preset first and second threshold values; and
increasing a transfer rate at which the real-time data is transmitted, when the data-loss rate is lower than both the first threshold value and the second threshold value, not changing the transfer rate when the data-loss rate is higher than the first threshold value and lower than the second threshold value, and decreasing the transfer rate when the data-loss rate is higher than both the first threshold value and the second threshold value.

4. The communication method according to claim 3, wherein the first threshold value is set at a value other than zero, the number of times the data-loss rate corresponds to a first state in which the data-loss rate ranges from zero to the first threshold value, a second state in which the data-loss rate ranges from the first threshold value to the second threshold value or a third state in which the data-loss rate exceeds the second threshold value is counted, whether the data-loss rate corresponds to the first data-loss state, the second data-loss state or the third data-loss state is determined in accordance with a count obtained by the counting means, and the transfer rate is controlled in accordance with the data-loss state thus determined.
